(19) United States
(12) Patent Application Publication
(10) Pub. No.: US 2024/0044123 A1
(43) Pub. Date: Feb. 8, 2024

(54) SYSTEM FOR INCREASING AND DISPLAYING EFFECTIVENESS AND EFFICIENCY OF STORMWATER INFRASTRUCTURE

(71) Applicant: P4 Infrastructure, Inc., Milwaukee, WI (US)

(72) Inventors: Joseph A. Diekfuss, Muskego, WI (US); Christopher M. Foley, Milwaukee, WI (US); David A. Oplinger, Milwaukee, WI (US)

(21) Appl. No.: 18/481,675

(22) Filed: Oct. 5, 2023

Related U.S. Application Data
(63) Continuation of application No. 17/302,071, filed on Apr. 22, 2021.
(60) Provisional application No. 62/704,130, filed on Apr. 22, 2020.
(60) Provisional application No. 62/704,759, filed on May 27, 2020.

(51) Int. Cl. E03F 5/10; E03F 5/042; E03F 1/00

(52) U.S. Cl. CPC E03F 5/107; E03F 5/042; E03F 1/002; E03F 2201/20

(57) ABSTRACT

An active water storage infrastructure management facility that includes a stormwater BMP comprising a storage gallery for containing a volume of stormwater runoff, a drain system in fluid communication with the storage gallery, a liquid level sensor disposed in the storage gallery for measuring the volume of runoff water introduced into the storage gallery, a fluid flow sensor disposed on the drain system to measure a portion of the volume of runoff water exiting the drain system, and a real-time-control valve disposed proximate an outlet end of the drain system. The facility may also include a control system in electronic communication with the liquid level sensor, the fluid flow sensor, and the real-time-control valve. The facility may be used to control the outflow of runoff through the real-time-control valve so as to optimize the operation of the facility for a particular design capability.

### CROSS-REFERENCE TO RELATED APPLICATIONS

This application is a continuation of U.S. patent application Ser. No. 17/302,071, filed Apr. 22, 2021, which claims the benefit of U.S. Provisional Patent Application No. 62/704,130, filed Apr. 22, 2020, and U.S. Provisional Patent Application No. 62/704,759, filed May 27, 2020, the entire disclosures of which is hereby incorporated by reference.

### BACKGROUND

Stormwater infrastructure best management practices (BMP) are designed using accepted industry standards applied in individual states through state regulations and technical standards and are modeled and designed using source loading and management modeling (SLAMM) software. BMPs are generally recognized as structural, vegetative and/or managerial practices used to treat, prevent, or reduce water pollution from stormwater runoff.

BMPs can be thought of more simply using the conceptual diagram shown in FIG. 3. When it rains, water runs over land and turns into stormwater surface runoff. The surface runoff picks up pollutants and, left unmitigated, carries the pollutants to streams, rivers, and lakes. To reduce the amount of pollutants entering waterways, stormwater best management practices (BMPs) are designed and constructed to filter the stormwater, and in many cases, infiltrate the water on site. Other BMPs (e.g. wet ponds, underground storage cisterns) detain stormwater for a period of time to allow particulate to settle out before the runoff is allowed to enter downstream waterways.

BMP design guidance is typically very conservative. For example, Wisconsin's technical standards for evaluating a site for infiltration provides three options for estimating infiltration rate at a site slated for future best management practice (BMP) installation (see https://dnr.wi.gov/topic/stormwater/documents/1002SiteEvalForInfiltr.pdf). Option 1 recommends digging a soil pit to evaluate the types of soils present at the site. The engineer must then select a standard infiltration rate based on published test results in the literature corresponding to the least permeable layer discovered in the pit. Option 2 allows infiltration to be measured directly using a double-ring infiltrometer test. This is better than Option 1 but is only representative of the location/day/time/conditions present when the test was conducted. In short, one set of double-ring tests define the subgrade infiltration rate used in the design of the BMP for the entire life of a BMP (intended to be in service 10-20 years minimum). Option 3 is essentially Option 1 with a correction factor (of less than 1) applied to the standard, published infiltration rates to account for compacted soil if efforts were not taken to mitigate such compaction during construction. These estimations typically prove very conservative and inaccurate.

Permeable pavement and biofiltration basins are BMPs which serve as filters capturing pollutants from stormwater runoff passing through their surfaces and their underground media and can be represented by BMP 200 shown in FIG. 3. As shown in FIG. 3, BMP system 200 includes the design rainfall modeled on historic data 202 to design for a rain event 204. The precipitation is funneled per topography of the defined drainage basin 206, wherein the BMP 200 includes a BMP storage 208 wherein the water is removed from the BMP 200 through a permeable substrate 210 via infiltration into the surrounding soil or substrate, or out of the under drain 212, which is configured to allow for a continuous outflow of retained water. As shown, these BMPs 200 rely on both subgrade infiltration through the permeable substrate 210 (also referred to in this document as subgrade seepage) and underdrain conveyance systems 212 to drain their storage galleries after rain or other precipitation events. Typically, the underdrain 212 is present and designed to prevent overflows of the BMP storage 208 and to ensure the BMP is emptied/drained within a specified drawdown period (typically 48-72 hours after a rain event).

Drawdown time is an important consideration when designing infiltration-type BMPs and can vary by jurisdictions. In Minnesota, for example, drawdown time is typically 48 hours, while it is 72 hours in Wisconsin. Each state or water jurisdiction may have similar or different drawdown times. There are several reasons infiltration-type BMPs must drain within an established time period including: (1) wet-dry cycling of the storage gallery; (2) minimizing the opportunity for mosquito breeding; (3) promoting suitable habitat for vegetation (bioswales); (4) promoting aerobic conditions (bioswales); and (5) ensuring storage capacity is available for the next rain event. See https://stormwater.pca.state.mn.us/index.php/Assessing_the_performance_of_infiltration

Known software packages like WinSLAMM (www.winslamm.com) conveniently allow engineers to input all these properties to evaluate resulting BMP efficiencies. WinSLAMM was developed to computerize the source loading and management modeling required to quantify the amount of pollutant captured by BMPs. At the time of this patent application, WinSLAMM is an approved model in Delaware, Georgia, Minnesota, New York and Wisconsin and it is referenced by stormwater design manuals in 16 other states across the US.

WinSLAMM documentation describes three mechanisms by which a BMP, like permeable pavement, can remove pollutants carried by stormwater (see http://winslamm.com/docs/WinSLAMM%20Model%20Algorithms%20v7.pdf). Stormwater is first filtered through the surface and bedding layers in the top portions of the pavement section removing larger-sized particles. The second pollutant removal mechanism is settling and can only occur if the stormwater is allowed to pond within a BMP. As water ponds inside a BMP, particles can begin to settle out at the bottom of the storage gallery. The third mechanism is through infiltration of stormwater directly into the subgrade beneath a BMP.

There is a tension when designing infiltration-type BMPs between infiltrating all water such that a 100% pollutant removal credit for every drop of stormwater runoff entering these systems is achieved with managing the risks of failure outlined previously due to failure to drain in advance of the next event. Engineers must consider both pollutant removal efficiency and drawdown time when designing infiltration-type BMPs. Often, pollutant removal efficiency is sacrificed to mitigate risk of failure. If an infiltration-type BMP is constructed without an underdrain near the bottom of the storage gallery, there is a chance stormwater runoff will not drain within the specified drawdown period. If this happens, the BMP is considered failed and must be reconstructed with an underdrain to receive pollutant removal credits. This may result in additional infrastructure spending and inefficiencies.

Thus, there is a need in the art to provide a system to maximize pollutant removal mechanisms to the greatest extent possible by sizing and locating underdrains within storage galleries such that stormwater is ponded for the full drawdown period after every rain event, with infrastructure which provides the necessary drainage features, but also does not require an increase in labor or active management of such BMPs. Moreover, there is also a need in the art to obtain information and display information which allows operators to monitor the functionality and performance of these BMPs to capture the necessary data to show compliance with federal and local regulations as well as demonstrate the efficiencies obtained.

### SUMMARY OF THE INVENTION

This patent describes the utility of an invention that maximizes the efficiency of stormwater BMPs using internet of things (IoT) and real time control (RTC) technologies. The invention is described within the context of a permeable pavement BMP system, but is equally applicable to other stormwater BMPs like bioswales, underground infiltration basins, wet ponds, dry ponds, underground storage cisterns, green/blue roof systems, or any stormwater management system that could benefit from monitoring performance and actively controlling effluent discharge to increase system efficiency.

The present invention is directed toward an active water storage infrastructure management facility that includes a stormwater BMP comprising a storage gallery for containing a volume of stormwater runoff, a drain system in fluid communication with the storage gallery, a liquid level sensor disposed in the storage gallery for measuring the volume of runoff water introduced into the storage gallery, a fluid flow sensor disposed on the drain system to measure a portion of the volume of runoff water exiting the drain system, and a real-time-control valve disposed proximate an outlet end of the drain system. In one embodiment, the real-time-control valve is moveable between an open position and a closed position, and when the real-time-control valve is in a closed position, no runoff water exits the drain system and wherein when the real-time-control valve is in an open position, the portion of the volume of runoff water exits the drain system.

One embodiment may include a control system in electronic communication with the liquid level sensor, the fluid-flow sensor, and the real-time-control valve. One embodiment may include the drain system being an underdrain. In one embodiment, the BMP includes permeable pavement, and the storage gallery is an aggregate sub-base.

In another embodiment, an active water storage infrastructure management facility operating system may comprise a permeable pavement surface, a permeable base material disposed under the permeable pavement surface, a underdrain system comprising a plurality of individual drain lines and having at least one outflow point, a control system for managing the operations of the water storage infrastructure, a plurality of sensors for measuring one or more operating parameter, wherein the sensors disposed in the underdrain system, and each of the plurality of sensors in electronic communication with the control system. They facility may further include at least one outflow valve disposed at the outflow point, wherein the outflow valve may be in electronic communication with the control system, and wherein the control system may operate the outflow valve based upon the measurements of one or more of the plurality of sensors.

The present invention may also include a method for using the active water storage infrastructure management facility that includes the steps of: measuring a volume of stormwater runoff introduced into a storage gallery of a BMP due to a precipitation event using at least a fluid level sensor disposed in the storage gallery, measuring a first portion of the volume of stormwater runoff that is removed from the storage gallery through a drain system in fluid communication with the storage gallery using at least one fluid flow sensor disposed on the drain system, and determining a second portion of the volume of stormwater runoff that is either maintained in the storage gallery or permeates through a subgrade adjacent to the storage gallery.

The method may also include the step of controlling an outflow of the drain system to control the second portion of the volume of stormwater runoff to optimize an operation of the BMP to meet one or more stormwater runoff compliance parameters. One embodiment of the method may also include the step of maintaining a maximum draw-down time of the storage gallery through controlling the outflow of the drain system.

In another embodiment, the method may include measuring a contained volume of runoff within the storage gallery using at least a fluid level sensor disposed in the storage gallery, obtaining a weather precipitation forecast, wherein the outflow of the drain system is controlled in real-time based upon the measurement of the contained volume of stormwater in the storage gallery and the weather precipitation forecast. In another embodiment, the method may include the step of maintaining a maximum draw-down time of the storage gallery through controlling the outflow of the drain system.

In another embodiment, the method may include determining the amount of one or more pollutants, which are removed by the stormwater BMP using the determined first portion of the volume of stormwater runoff and determining the amount of the one or more pollutants removed by the stormwater BMP through infiltration through a subgrade of the BMP using the determined second portion of the volume of stormwater runoff. This embodiment may further include controlling an outflow of the drain system to control the volume of stormwater runoff in the storage gallery to optimize the amount of the one or more pollutants which are removed by the stormwater BMP through infiltration through the subgrade of the BMP. Further, this embodiment may further include maintaining a maximum draw-down time of the storage gallery through controlling the outflow of the drain system.

The method of operating the active water storage infrastructure management facility may also include the steps of measuring a contained volume of runoff within the storage gallery using at least a fluid level sensor disposed in the storage gallery, and obtaining a weather precipitation forecast, wherein the outflow of the drain system is controlled in real-time based upon the measurement of the contained volume of stormwater in the storage gallery and the weather precipitation forecast.

The present invention also includes a method for presenting information to a user of a system for monitoring stormwater infrastructure efficiency and progress related to EPA compliance comprising the steps of calculating a modeled data point of one or more infrastructure performance elements of one or more stormwater infrastructure elements, measuring a value of actual performance of the one or more infrastructure performance elements of the one or more stormwater infrastructure elements, and displaying a comparison of the modeled data point and the value of actual performance in a graphical format.

Other aspects and advantages of the present invention will be apparent from the following detailed description of the preferred embodiments and the accompanying drawing figures.

### DESCRIPTION OF THE SEVERAL VIEWS OF THE DRAWINGS

The accompanying drawings form a part of the specification and are to be read in conjunction therewith, in which like reference numerals are employed to indicate like or similar parts in various views.

FIG. 1 is a schematic sectional view of one embodiment of a prior art BMP example with underdrain;

FIG. 2 is a schematic sectional view of one embodiment of a BMP system in accordance with the teachings of the present invention;

FIG. 3 is a schematic illustration of one embodiment of a prior art BMP system;

FIG. 4 is a schematic sectional view of one embodiment of a BMP system in accordance with the teachings of the present invention;

FIG. 5 is a schematic flow chart of one embodiment of a method for using a BMP system in accordance with the teachings of the present invention;

FIG. 6A is a schematic pie chart view illustrating the compliance requirements and current pollution reduction provided by existing BMPs of a city in accordance with the teachings of the present invention;

FIG. 6B is a schematic view of two alternative compliance strategies in accordance with the teachings of the present invention;

FIG. 7 is a schematic view of one embodiment of a display system for illustrating the compliance requirements from removing total suspended solids (TSS) and progress of a city in accordance with the teachings of the present invention showing modeled pollutant reduction values;

FIG. 8 is a schematic view of the display system of FIG. 7 showing the information for measured pollutant reduction values;

FIG. 9 is a schematic view reproducing and comparing FIGS. 7 and 8.

FIG. 10 is a schematic view of one embodiment of a display system for illustrating the compliance requirements for removing TP and progress of a city in accordance with the teachings of the present invention showing modeled pollutant reduction values;

FIG. 11 is a schematic view of the display system of FIG. 10 showing the information for measured pollutant reduction values;

FIG. 12 is a schematic view reproducing and comparing FIGS. 10 and 11.

### DETAILED DESCRIPTION OF THE INVENTION

The following detailed description of the present invention references the accompanying drawing figures that illustrate specific embodiments in which the invention can be practiced. The embodiments are intended to describe aspects of the present invention in sufficient detail to enable those skilled in the art to practice the invention. Other embodiments can be utilized and changes can be made without departing from the spirit of the scope of the present invention. The present invention is defined by the appended claims and, therefore, the description is not to be taken in a limiting sense and shall not limit the scope of the equivalents to which such claims are entitled.

The present invention is directed toward a system that maximizes the efficiency of stormwater BMPs using internet of things (IoT) and real time control (RTC) technologies. The invention is described within the context of one embodiment being a permeable pavement BMP system, but is equally applicable to other stormwater BMPs like bioswales, underground infiltration basins, wet ponds, dry ponds, underground storage cisterns, green/blue roof systems or any stormwater management system that could benefit from monitoring performance and actively controlling effluent discharge to increase system efficiency.

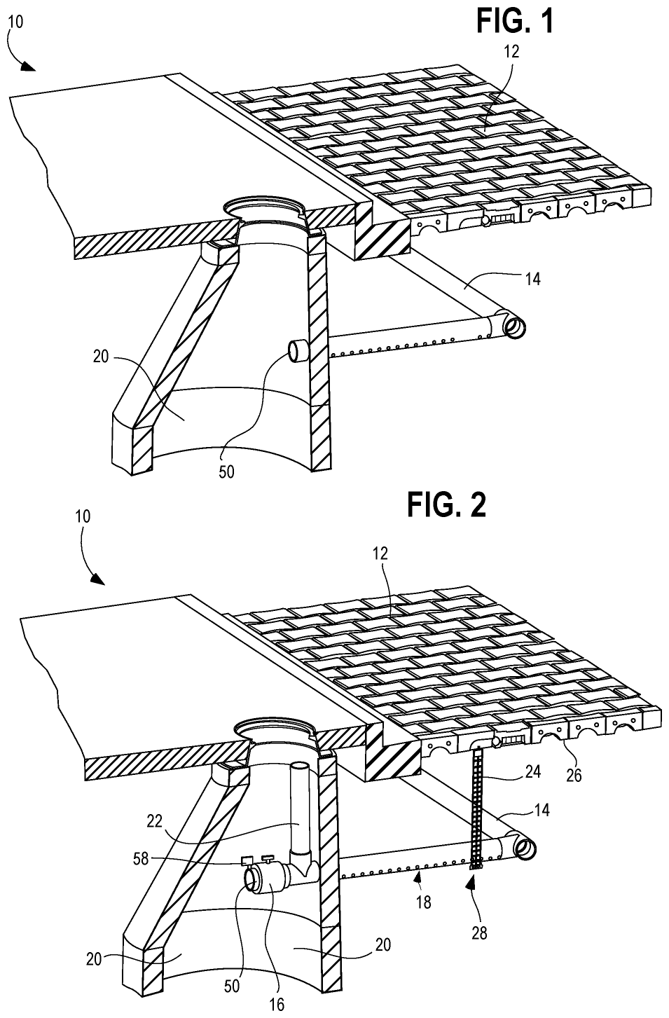

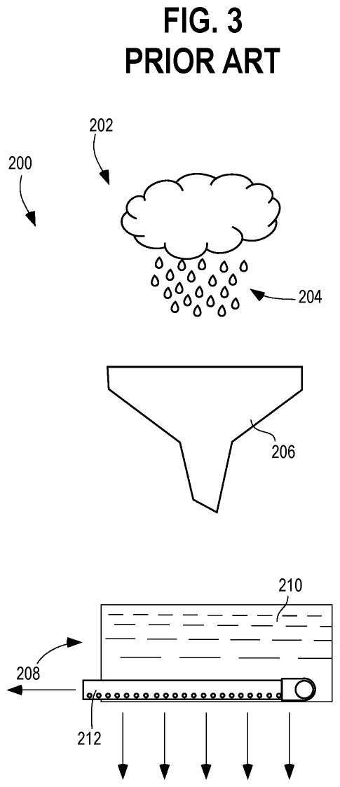

FIG. 1 illustrates one embodiment of a stormwater BMP system 10 installation showing permeable pavement 12 with underdrain 14. Underdrain 14 empties from an outlet end 50 into manhole 20. FIG. 2 shows another embodiment of a BMP system 10 that comprises some simple sensors and controls which provide the functionality claimed in the present invention. This embodiment includes the implementation and monitoring with the following IoT and RTC devices installed, particularly a real-time control valve 16 disposed on end 50 of an outflow pipe 18 of the underdrain 14 into a storm sewer manhole 20 which is connected to a storm sewer pipe system (not shown). A vertical overflow standpipe 22 may be disposed within the manhole 20 upstream of the control valve 16 to provide an outlet to prevent the system from being overloaded (flooded) or to mitigate the effects of overloading. Further, a water level sensor 24 may be disposed between the underdrain 14 and the bottom 26 of the permeable pavement 12 to measure the presence of any volume of standing water 52 in the storage gallery 54 between the pavement 12 and the underdrain 14. The water in the storage gallery 54 may permeate through the subgrade 28 or travel out of the BMP system 10 through the underdrain 14. The storage gallery 54 is generally an engineered layer of sand, aggregate base material, other geotechnical material, a mix, or any combination thereof, or any other material now known or currently developed which provides the desired or required drainage performance. However, the present system may also be implemented in other BMP systems wherein the storage gallery 54 is a storage tank, a cistern, a rooftop or below grade water storage structure or pool, a detention pond, or retention pond. The subgrade 28 generally starts at the bottom of the storage gallery (or tank) and extends downward. The subgrade 28 is typically the native soil of the location hosting the BMP, but in some situations could be engineered to include sand, aggregate, or other geotechnical material to affect drainage.

FIG. 2 also shows that a fluid flow sensor system 58 may be disposed proximate the outflow end 50 of underdrain 14. Fluid flow sensor system 58 may measure one or more of the velocity of the water leaving the outflow end 50 and the height of the water leaving the outflow to determine the volume of water flowing out of the outflow end 50 in real-time, which provides a total when tracked over a certain period of time

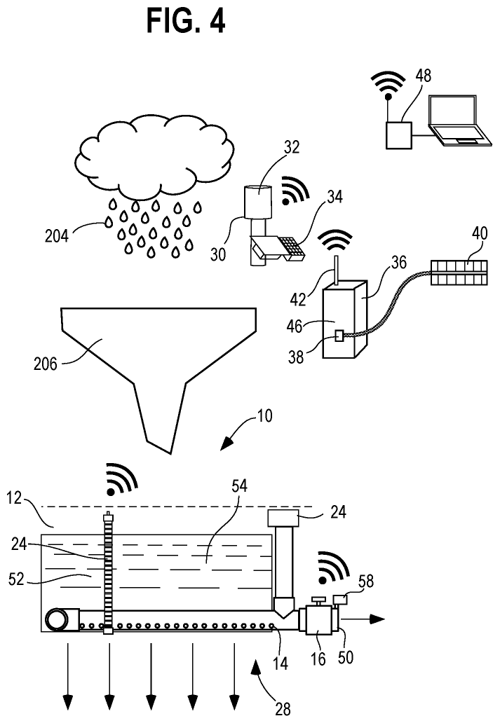

FIG. 4 illustrates an embodiment of BMP system 10 in accordance with the present invention. BMP system 10 may include a weather sensor 30 that includes a rain gauge 32, and may also include one or more environmental sensors 34, wherein the environmental sensors may measure and record one or more of temperature, barometric pressure, and relative humidity. Rain gauge 32 may capture rainfall or precipitation and communicate to the computer 36 in real-time. Any of the sensors described above may measure the desired environmental condition in real-time. In addition, BMP system 10 may include sensors which can measure one or more qualities of the stormwater runoff in real-time, like the concentration of one or more pollutants, water clarity, or other water quality characteristics. BMP system 10 may include one or more computer(s) 36 that are connected to the weather sensor 30 and other sensors and controls in system 10. Computer 36 may be on or off site. For on-site computers 36, the computer 36 may include one or more battery pack(s) 38 which are charged by one or more solar panel(s) 40. This gives system 10 an “off the grid” capability for power and computation. On-site computers 36 may also be hard-wired into existing site infrastructure for both power and data communications.

BMP system 10 may also include one or more antenna(s) 42 which connect system 10 to the computer, one or more sensors and/or controls which connect BMP system 10 to the cloud for the transmission and receipt of data through the internet. Antenna 42 may be one or more of a cellular, Wi-Fi, Bluetooth, satellite, or LoRa, or any future similar technology. In some embodiments, multiple communication technologies such as cellular, Wi-Fi, Bluetooth, satellite, or LoRa, may be incorporated into the system 10. For example, computer 36 may be connected to one or more sensors or controls via Bluetooth, and computer 36 may be connected to the cloud for data transmission and/or back up via a wireless cellular connection. Alternatively, BMP system 10 may be hardwired to the internet for hard-wired data transfer at the site.

BMP system 10 may also include one or more water-tight enclosures 44 for electronics, computers and antennas or other electrical components. The BMP system 10 may also include water-tight cables and terminations/connectors 46. The components of BMP system 10 may utilize a number of known terminations/connectors and infrastructure elements and mounting hardware, such as concrete pavers, steel brackets, steel poles, concrete foundations, perforated PVC sensor shells, etc., to mount and secure the components of BMP system 10.

While underdrains 14 do not make up a large portion of the cost of a BMP (if they are installed during original construction), they do affect a BMP's ability to reduce pollutants, which drives up the cost per pound of pollutant removed. BMPs capable of infiltrating all stormwater passing through them remove 100% of pollutants carried by runoff. Stormwater filtered through a BMP, then discharged through an underdrain reduces only a portion of the pollutants carried by the runoff allowing some pollutants to escape the BMP and to enter the public waters of the drainage system. Water discharged through permeable pavement underdrain is assumed to remove somewhere near 65% of total suspended solids (TSS) and 35% of total phosphorus (TP)—both significantly less than 100% achieved through a full infiltration system.

The size (diameter), location and number of underdrains 14 are important when designing a BMP system 10. All three factors help to determine how quickly BMP system 10 will empty after water enters the system. A large underdrain 14 at the bottom of a storage gallery 54 will provide an easy flow path for water to exit the BMP, limiting the ability for stormwater to be stored (ponded) in the storage gallery 54 and/or infiltrate into the subgrade 28. Raising the underdrain 14 to a higher elevation, shrinking the size, or reducing the number of underdrains 14 used within the storage gallery 54 all help to promote ponding and infiltration thereby increasing BMP pollutant removal efficiency. By doing this, however, there is increased risk that the BMP 10 will not drain within the specified drawdown time. If underdrain 14 is not installed within the cross-section of the BMP 10, observation wells are required to be installed to allow water level monitoring from the surface. Some state regulations require the observation wells be visited at least once per year at the drawdown time after a rain event of 0.5 inches or more to verify the storage aggregate is draining effectively.

When designing the present BMP system 10, designers recognize that when it rains, stormwater begins to run off surrounding area and drain to a BMP 10. When it reaches the BMP 10, the water permeates through its surface 12 and percolates into the storage gallery 54. The stormwater can then either infiltrate into the subgrade 28 beneath the storage gallery 54 or exit through an underdrain 14. As described previously, BMPs with underdrains 14 at the bottom of their galleries do not provide much opportunity for stormwater to infiltrate because the underdrain 14 provides a much easier path for the water to take out of the storage gallery 54. When analyzing a BMP, engineers quantify the total volume of stormwater runoff, V_{T}, the portion of total volume infiltrated into subgrade, V_{inf}, the portion of total volume discharged through underdrain, V_{U}, and the portion of the total volume that will bypass the system altogether (e.g. due to overflow), V_{B}.

V_{T}=V_{inf}+V_{U}V_{B} (1)

The three potential paths for stormwater runoff have the following pollutant removal efficiencies: (1) enter the BMP and completely infiltrate into the ground beneath the surface providing 100% pollutant reduction; (2) enter the BMP, partially infiltrate into the ground providing 100% pollutant reduction for this portion of rainfall infiltrated, and partially discharge the remaining through an underdrain where it is conveyed to surface waters providing a BMP-specific fraction (e.g. 35-65%) pollutant reduction for this portion depending upon the volume of water that fully infiltrates versus the volume entering the underdrain system; or (3) bypass the BMP providing 0% pollutant reduction for this portion. The process is iterative, and the BMP is sized such that V_{B} goes to zero to avoid having any runoff by-pass the BMP.

Many BMPs have been designed and constructed across the United States using conservative values for the infiltration rates recommended by existing design guidance documents. Given the conservative nature of these standards, when a BMP has an underdrain system 14, it is likely that many BMPs are infiltrating larger fractions of stormwater volume passing through them than they are currently being credited. However, prior to the present invention 10, it is not known in the art how to determine how much infiltration is taking place in order to have data to support a larger credit for removal of TSS and TP than provided in the initial design.

In use, the BMP system 10 of the present invention can be implemented into new or existing BMP systems with underdrains 14 to show the actual reduction in total suspended solids (TSS) and total phosphorus (TP) so that municipalities can demonstrate that the BMPs actually remove more TSS and TP than estimated in current passive design according to the current conservative design guides when demonstrating or evaluating compliance with the EPA runoff requirements. As part of the compliance strategy, the present BMP system 10 can also be linked with a private BMP's implementing system 10 through which a municipality may contract or otherwise consider in its compliance efforts and have the actual data to back up the private BlVIP's contribution to such compliance. This has the potential to save municipalities, and ultimately taxpayers, a substantial amount of money in both reduction of CAP-X and ongoing operations and maintenance while still providing the necessary runoff and environmental standards set forth by a state or the EPA.

In one embodiment of BMP system 10 of the present invention operating with an underdrain 14, the fluid level of the BMP system 10 may be monitored using one or more fluid level sensor(s) 24. In one embodiment, the fluid level sensor 24 may be a mechanical float sensor. Other types of fluid level sensors can also be used. The float of the fluid level sensor 24 has a specific gravity less than 1.0. When installed within a BMP system 10, the float rises as water enters the system 10 and is present in storage gallery 54, sending a voltage reading to a wired computer 36. The voltage is received by the computer 36 and then sent wirelessly using cellular, Wi-Fi, or LoRa antenna 42 to a cloud-based database 48. Data transmission to the cloud can also be accomplished via hard-wired connections to existing site infrastructure where available. Once in the cloud 48, voltage is interpreted and converted by software to a corresponding water level. Voltage may also be interpreted via edge computing at computer 36. In one embodiment, the water level can be measured to around a 0.25″ resolution, but depending upon the application and/or the water level sensor 24 being used, higher or lower sensitivity may be implemented. The overall measuring range for the fluid level sensors 24 used in the present BMP system 10 can vary from as low as a couple of inches to higher than fifty feet.

At least one real-time-control (RTC) valve 16 is installed at the BMP outlet 50 (i.e. the end that drains to storm sewer or open water). In the present system 10, the valve 16 is maintained in a normally closed condition. This means that, under normal conditions, any water entering a BMP system 10 (and its underdrain 14) is not allowed to exit the system 10, except through infiltration into subgrade 28 or through evaporation. If subgrade infiltration and/or evaporation is not capable of draining a BMP 10 within specified drawdown times, the valve 16 can be remotely opened. The valve 16 can also be remotely opened if there is risk of system 10 overflow or bypass. In other words, if significant precipitation events occur or normal precipitation events spaced closely together (i.e. back-to-back storms), there is potential for the BMP system 10 to overflow if infiltration through subgrade 28 is the only exodus path for the filtered runoff. The valve 16 should be opened in this scenario to ensure all runoff enters the BMP system, even though most of the runoff would be draining through underdrain 14 discharge instead of infiltration. It is better for runoff to exit the underdrain 14 after being filtered through a BMP system 10 than bypassing a BMP altogether and not having any removal of TSS or TP.

In one embodiment, valve 16 could be a variable flow valve so that the outflow rate could be optimized based upon the measured precipitation from the rain gauge 32 so as to optimize subgrade infiltration, but still meet required drawdown times. Further, the operation of valve 16 could be used to manage the outflow rate with other types of BMPs for at least the following purposes: maximize the time water is stored to maximize settlement of pollutants, maximize the use of storage capacity to even out or manage the load of stormwater runoff being introduced into the downstream network and/or processed in water treatment plants, or other optimization of system capacity limits or environmental compliance issues.

The valve 16 can be opened or closed remotely using online dashboard controls, which connects the BMP system 10 with a remote computer through the internet. Notifications via email or text messages can be sent to asset owners/managers alerting them of high-water levels. High water level thresholds may be defined by the asset owners/managers. Remotely opening the valve 16 can be done manually through the online dashboarding environment or physically in the field, or it can be done autonomously by the system using BMP water level and local rainfall data. For example, if water level rises above a user-defined threshold, is still in the drawdown period from the previous rain event, and it begins to rain again, the system 10 could automatically open the valve 16 to drain the system 10 and provide storage capacity for the new runoff.

In another embodiment, one or more overflow standpipes 22 can be installed immediately upstream of the RTC valve 16. The overflow standpipe 22 would minimize the potential for any stormwater runoff to bypass the system 10. In this scenario, the RTC valve 16 would only be opened if the system 10 did not drain within the specified drawdown time, not to generate storage capacity ahead of another rain event.

One embodiment of BMP system 10 measures and documents at least the following for stormwater BMPs either in temporal proximity to a precipitation event or in real-time: site-specific rainfall, temperature, barometric pressure, and relative humidity using a weather sensor 30; current water level within BMP system 10 using a fluid level sensor 24; volume of stormwater infiltrated into subgrade 28 using a computer 36 and/or fluid level sensor 24 and/or the measured rainfall amounts from rain gauge 32 using known computational methods; volume of stormwater discharged through underdrain 14 or other outlet pipe measured or calculated using a flow sensor and/or the flow properties of the outflow valve 16; and pollutant removal efficiency using the volume of stormwater infiltrated into subgrade 28, the volume of water discharged through the one or more outlet 50 of underdrain 14 or other outlet pipe.

As an example of why the present BMP system 10 should be implemented into a compliance program, there have been instances in a Southeast WI municipality where permeable pavement underdrain monitoring after rain events showed little to no flow through the underdrain. This indicates that for at least some BMPs, most, if not all, stormwater runoff is actually infiltrating into the subgrade 28 rather than being discharged through the underdrain.

In contrast, when comparing this real-world observation to the WinSLAMM software model used to size the permeable pavement BMP and to quantify its pollutant removal efficiency, the model uses a conservative subgrade seepage rate of only 0.04 in/hr. This value is about as low as possible and is representative of a silty clay subgrade material. If the subgrade 28 material can only infiltrate stormwater at a rate of 0.04 in/hr as indicated in the model, the underdrain 14 monitoring efforts would have revealed higher flows after rain events. Given the discrepancy between the model and what is being seen in the field, it is likely the BMP at hand can receive more pollutant removal credit than is currently being utilized for the compliance analysis. This would benefit the property owners as well as the municipalities (and the environment) as the actual pollutants being discharged is less than what the model has estimated.

Measuring the actual pollutant removal efficiency using BMP system 10 is important because communities which drain to impaired bodies of water, as identified by states and approved by the Environmental Protection Agency (EPA), are required to meet a pollutant budget commonly referred to as a Total Maximum Daily Load (TMDL). TMDLs have been established for watershed basins draining to impaired waterways across the United States. Each basin's TMDL is unique and can be further discretized into separate reachsheds. Pollutant load allocations are defined for each reachshed and depend on the type of impairment present within the waterway to which the reachshed drains.

As an example, parts of the storm sewer system and waterways in the Village of Whitefish Bay (WFB) in Wisconsin drains into the Milwaukee River. WFB is a relatively small municipality located in SE WI, just north of Milwaukee. The Milwaukee River Basin is broken up into many (30+) reachsheds, each with their own pollutant load allocations. The portions of WFB that drain to the Milwaukee River occupy reachsheds MI-27 and MI-32. These reachsheds in portions of WFB are subject to the TMDL requirements. The portions of WFB not included in these reachsheds drain directly to Lake Michigan and are not subject to TMDL requirements; rather, they must conform to WFB's Municipal Separate Storm Sewer (MS4) Wisconsin Pollutant Discharge Elimination System (WPDES) permit requirements. See 2017 Village of Whitefish Bay TMDL Stormwater Quality Management Plan—Report, prepared by Strand & Associates.

The pollutant load allocations per TMDL reach of MI-27 and MI-32 are as follows (expressed as % reduction from baseline conditions):

| | | |
|---|---|---|
| MI-27 | 73% TSS | 54% TP |
| MI-32 | 58% TSS | 23% TP |

For this application, we will focus on how the information related to the removal of TSS and TP from the run-off for MI-27 may be shown using the presently described display system. What these numbers mean is that WFB must remove 73% of the TSS and 54% of the TP from their runoff in reachshed MI-27 to achieve TMDL compliance. To comply, WFB must determine how much TSS and TP they are currently removing. If WFB can determine what their current stormwater BMPs are capable of in terms of pollutant reduction for TSS and TP, they can determine their compliance gap (i.e. the delta between where they are currently and where they need to be for EPA compliance).

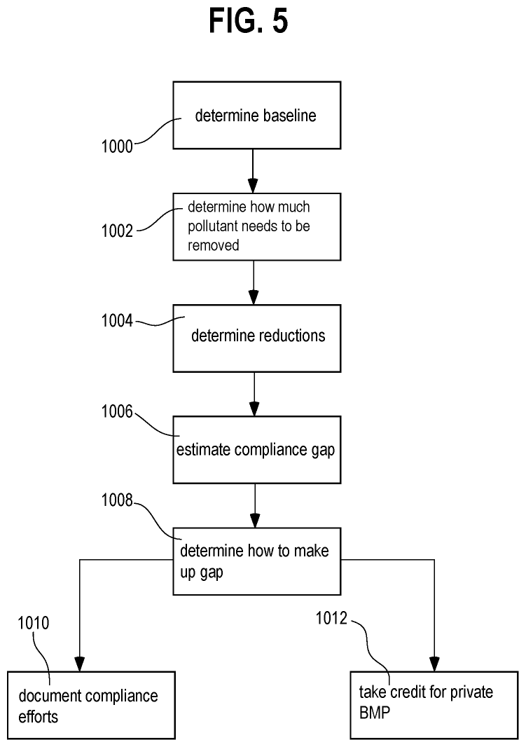

One method for using BMP system 10 is shown in FIG. 5. In step 1000, to begin determining how much TSS and TP WFB currently removes, a baseline estimate for pollutants generated by runoff within communities are computed assuming no BMPs are present. In other words, baseline conditions are the worst-case scenario providing the maximum amount of pollutant entering streams, rivers, and lakes. Pollutant loads depend on size of watershed, land-use distribution, rainfall quantity and intensity, etc. In step 1002, the load allocations for each reachshed are compared to baseline pollutant loads to help determine how much pollutant needs to be removed or captured by BMPs in each reachshed.

In step 1004, the reductions provided by the BMPs are determined by accounting for existing stormwater BMPs and their ability to capture pollutants. Typically, and conventionally, this is a task completed by engineering consultants who rely heavily on governmental guidance documents and SLAMM models to come up with the pollutant reduction credit. These calculations are currently being performed using the conservative industry design guidelines and methods. After an analysis is performed, in step 1004, the results can be expressed in the form of total pounds of pollutant removed or expressed as a percent reduction in pollutant for the reachshed. As long as the BMP is designed, constructed, operated, and maintained in accordance with the guiding technical standards, pollutant reduction credit commensurate with the BMP's pollutant removal ability is given to the community.

At this point, in step 1006, the community can estimate their compliance gap, if any. Pollutants captured by existing BMPs, expressed as percent reduction within the reachshed, are compared to the TMDL goal for that reachshed. In the WFB example (specifically reachshed MI-27), there are four existing structural BMPs reducing TSS by 14.2% and TP by 10.5%. This means there are reduction gaps of 58.8% and 43.5% for TSS and TP, respectively using the current conservative industry design guidelines and methods—see 2017 Village of Whitefish Bay TMDL Stormwater Quality Management Plan—Report, prepared by Strand & Associates.

In step 1008, the community will need to determine how to make up for the gap, either by building additional BMPs or by purchasing compliance credits. In step 1010, the community will need to document all of the compliance efforts to demonstrate compliance with the TMDL for both the State and the EPA.

TMDL communities, like WFB, can benefit from the present BMP system 10 by using the actual measurements to demonstrate that the existing infrastructure is more efficient than SLAMM models and current conservative industry design guidelines and methods are giving them credit.

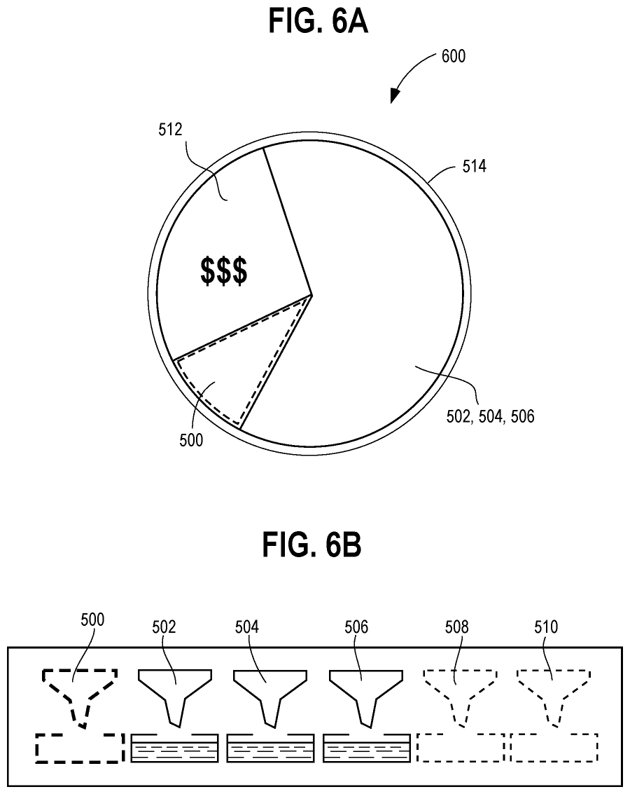

For a more specific example, FIG. 6A shows an application of an example of a BMP system and method for implementation. FIG. 6A illustrates a situation in which many TMDL communities currently find themselves. For this example and case explanation, we'll refer to the community as City X 600.

In this example, City X 600 knows they are not in compliance with the EPA requirement 514 for water quality of run-off water. Based on their consultant's reporting, City X 600 has already constructed three BMPs (502, 504, 506 in FIG. 6B) which are shown to remove 60% of the pollutants required to achieve compliance, thus, City X 600 has a compliance gap 512 and must increase the removal of pollutants in order meet the EPA requirements. Referencing FIG. 6B, City X 600 has two alternatives to choose from as they establish a stormwater management plan bringing them into water quality compliance. Both require using at least two additional BMP's to obtain compliance.

As shown in FIG. 6B, as part of step 1008, the following alternatives would be performed in the industry without utilizing the BMP system 10 of the present invention. The first alternative step 1010 would be to construct new BMPs 508 and 510 to make up the gap entirely with publicly owned BMPs 508 and 510. All BMPs 502, 504, 506, 508 and 510 would be owned and maintained by City X 600. In another alternative, a second step 1012 may include City X 600 taking credit for private BMP 500 by putting together a maintenance agreement with the private company which owns BMP 500. In exchange, the private owner may be credited stormwater utility fees and City X 600 would cut their stormwater capital expenditures (CAP-X) in half because they'd only need to construct one of BMP 508 or 510, but not both. BMP 500 would be privately-owned and maintained while BMPs 502, 504, and 506, and only one of BMP 508 or 510 would be publicly owned and maintained by City X 600. Both alternatives 1010 and 1012 require City X 600 to design and construct at least one new BMP 508 or 510 to bring their community into compliance. Both alternatives assume only existing design and removal verification methods are available to the community through the SLAMM modeling and conservative design guidelines, thus, City X's alternatives and compliance plan rely upon the conventional conservative estimates and calculations.

Now, using the BMP system 10 of the present invention, as an alternative step 1004, City X 600 can install BMP system 10 into BMPs 502, 504, and 506, all of which are already-built BMPs owned and maintained by City X 600. In this example, after installing and monitoring BMP system 10, it is measured that BMPs 502, 504, and 506 each show a 25% increase in pollutant-removing efficiency as shown in FIG. 6B. When determining the compliance gap in step 1006, this measured observation is equivalent to adding 0.75 BMPs to the already-built category when determining the reductions in pollutant removal provided by the BMP. As the compliance gap is then reduced, this would necessarily have the potential to reduce the CAP-X costs by 37.5% and 75% for design alternatives 1 and 2, respectively, as the gap is decreased, thereby decreasing the BMP capacity that must be newly constructed.

Let's now assume City X 600 focuses on Alternative 2 and decides to install the current invention into the privately-owned BMP 500. Since all BMPs 502, 504, 506, and private BMP 500 are assumed the same in this example, City X 600 would again see a 25% increase in pollutant-removing efficiency. In total, with four BMPs 500, 502, 504, 506 retrofitted with the BMP system the demonstration of the actual performance of these BMP systems increases the removal performance of the four existing BMPs to be the equivalent of adding one whole BMP. This would bring their tally up to five total BMPs in actuality, compared to four under the conservative modeling method. At five equivalent BMPs provided by BMPs 500, 502, 504, 506 including the present BMP system 10, City X 600 has achieved compliance with an alternative that reduced their CAP-X costs by 100% because it does not require the construction of any additional BMPs 508 or 510. In some cases, because of the conservatism in the existing design methods and the variations in the actual performance of a BMP, it is also likely that some BMPs prove to provide more than 25% increased efficiency. In this situation, City X 600 would have excess pollutant removal capacity and therefore may be able to turn their existing stormwater BMPs into revenue generating assets for their stormwater utility funds by selling credits to other communities in their basin.

Moreover, in some embodiments, the present BMP system 10 can be actively managed in operation to maximize the pollutant-removing efficiency of a system based upon the experienced weather and environmental conditions to provide even better environmental benefit. For example, underdrain 14 of BMP system 10 may be closed during certain rain events to maximize infiltration through the soil and subgrade 28, and BMP system 10 may open the control valve 16 once a pre-determined rainfall amount or rate is obtained so as to maximize the amount of time that the BMP operates at 100% pollutant-removing efficiency through infiltration only.

By retrofitting existing BMPs with the present BMP system 10, TMDL communities have an ability to significantly reduce their stormwater infrastructure CAP-X costs while still obtaining compliance, and in some cases, generate excess income through selling credits to other communities if actual performance of the BMPs exceeds TMDL requirements for each TMDL reach subject to environmental regulation.

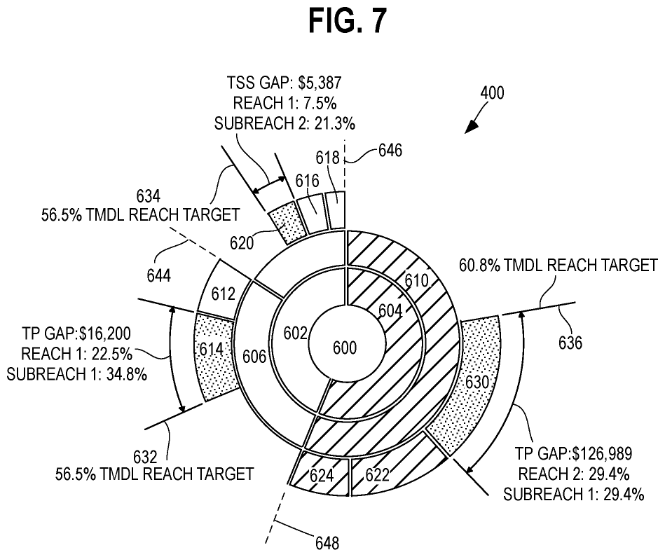

Tables 1-4 and FIGS. 7-12 illustrate how the use of BMP system 10 and its effects may be displayed and communicated to a community (City X 600) to view progress toward EPA TMDL compliance. A display system 400, as laid out in Tables 1-4 and FIGS. 7-12, provides a display system for presenting TMDL compliance of City X 600 which can be used to visually compare between modeled information and measured data. The modeled information and measured data were created for use in this patent to illustrate how inclusion of IoT and RTC technologies within the present system 10 can affect a community's progress toward EPA TMDL compliance. This display system 400 is intended to illustrate the effects of increased pollutant removal efficiency obtained by the present system for increasing efficiency and monitoring stormwater on TMDL compliance progress compared to the models currently used by the EPA and other regulatory agencies.

While this patent describes display system 400 for displaying EPA TMDL compliance progress, it should be noted that the system 400 is equally applicable to Municipal Separate Storm Sewer (MS4) permitting compliance where actual conditions can be monitored and compared to established models which are used in permitting and ongoing compliance programs. Further, this system can be extended to volume monitoring activities and applications included within combined sewer systems and networks.

Tables 1 and 3 provide baseline pollutant loads for Total Suspended Solids (TSS) and Total Phosphorus (TP), broken down by reach and subreach according to established regulatory models. Progress toward TMDL compliance is shown for each reach in both pounds and percent based upon modeled information in Table 1. Table 3 provides updated progress toward TMDL compliance after incorporating the present system 10 and utilizing the system to observe and measure performance data of each existing BMP 612, 616, 618, 622, and 624, new BMP 626, and private BMP 628.

Table 2 compares modeled pollutant reductions with TMDL required reductions to quantify compliance gaps and corresponding TSS and TP cost gaps.

Table 4 compares updated, measured pollutant reductions with TMDL required reductions to quantify compliance gaps (or credits) and corresponding TSS and TP cost gaps (or credits).

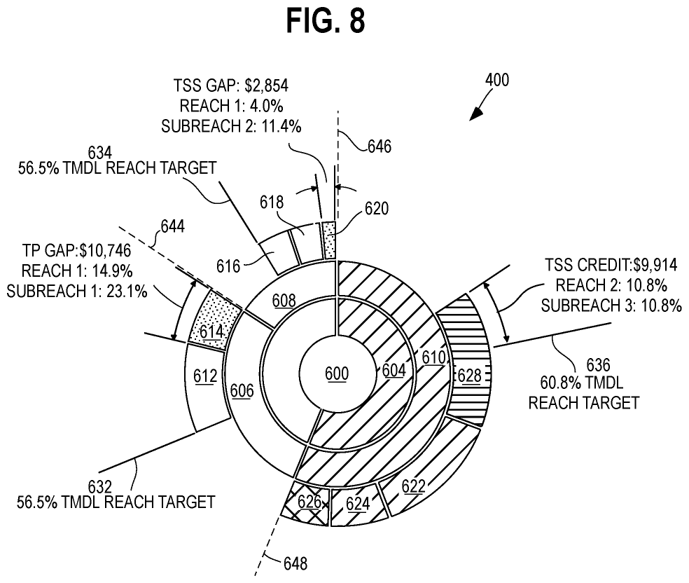

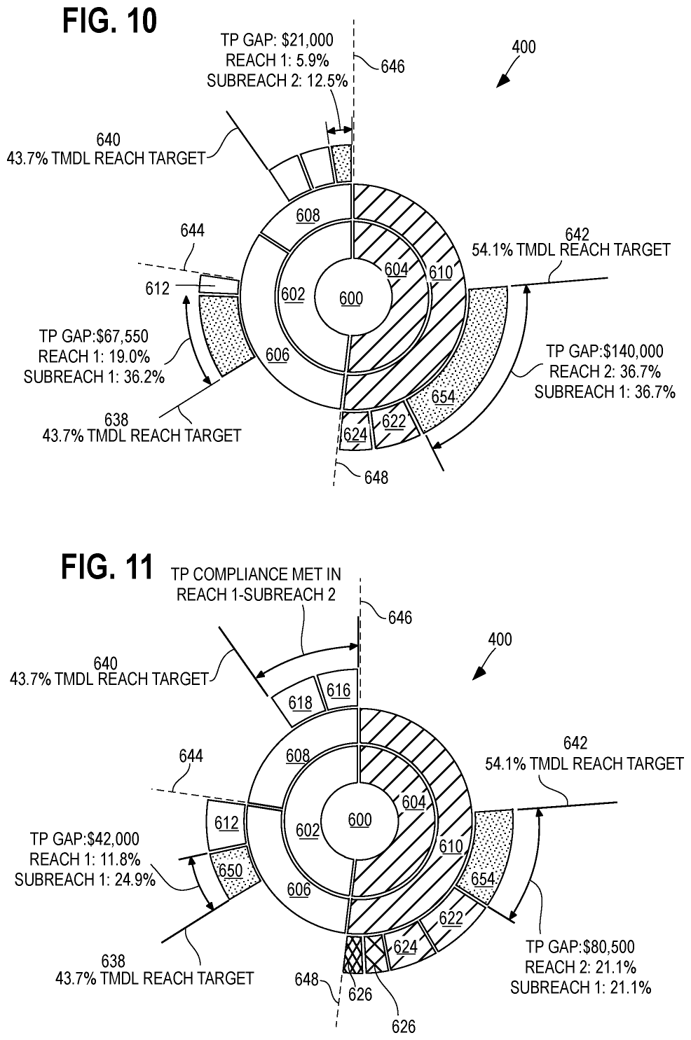

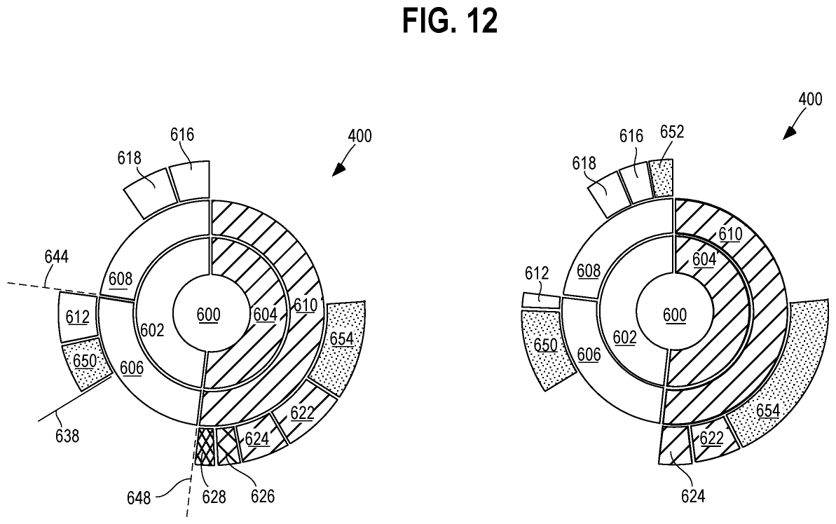

The numbers and call-outs shown in FIGS. 7 and 10 can be found in Tables 1 and 2. The numbers and call-outs shown in FIGS. 8 and 11 can be found in Tables 3 and 4.

When looking at the sunburst plots provided in FIGS. 7-12, it is important to note that only the outer-most ring changes when comparing modeled to measured conditions. The first ring, or inner-most ring, is separated into reaches 602 and 604 within a community and the portions are sized according to the total amount of pollutant possible within those reaches. The second ring, or middle ring, is separated into subreaches 606, 608, 610 and the portions are sized according to the total amount of pollutant possible within those subreaches. The third ring, or outer-most ring, is separated into BMPs, gaps, or blanks and the portions are sized based upon the amount of pollutant load captured, amount of pollutant load needing to be captured to meet TMDL compliance, or amount of pollutant load that can be captured to generate TMDL pollutant credits, respectively.

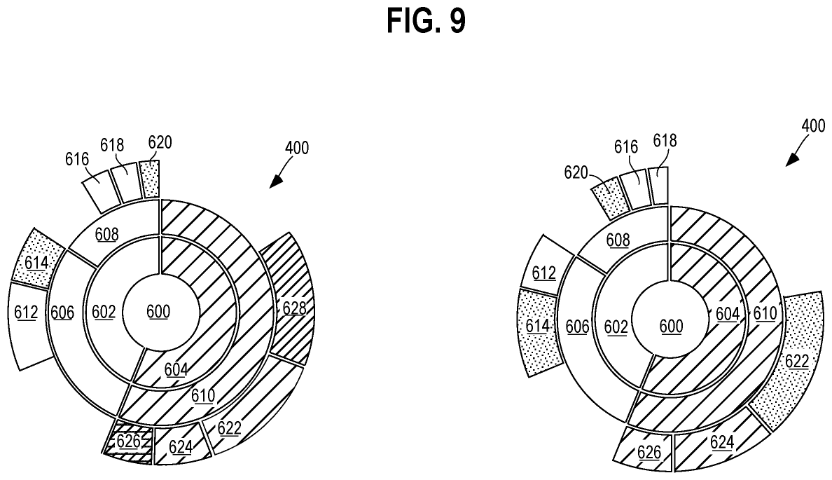

FIGS. 9 and 12 show side-by-side example sunburst plots of TSS and TP pollutant loads, respectively, comparing modeled information to measured data as a method for presenting the information to a user in an easy to understand arrangement.

FIGS. 7 and 8 show annotated versions of the plots provided in FIG. 9. In particular, in FIG. 7, City X 600 includes a first reach 602 and a second reach 604. First reach 602 includes a first subreach 606 and a second subreach 608, and second reach 604 includes a third subreach 610. City X 600 also includes a first BMP 612 in first subreach 606 and an identified TSS compliance gap 614. City X 600 also includes a second BMP 616 and third BMP 618 in second subreach 608 and an identified second TSS gap 620. City X 600 also includes a fourth BMP 622 and a fifth BMP 624 in third subreach 610. Further, third subreach 610 may also include a new BMP 626, a private BMP 628, and a TSS compliance gap 630. These tables also provide the removal efficiencies and corresponding pollutant loads captured for existing BMPs 612, 616, 618, 622, and 624, new BMP 626, and private BMP 628 corresponding to modeled information (Table 1) and measured data (Table 3). FIGS. 7 and 8 graphically show for each subreach 606, 608 and 610, a first zero reference line 644 for first subreach 606, a second zero reference line 646 for second subreach 608 and a third zero reference line 648 for third subreach 610. These reference lines correspond to zero pollutant load captured by the BMPs within each subreach. Similarly, each subreach 606, 608 and 610, includes a first compliance line 632 for first subreach 606, a second compliance line 634 for second subreach 608, and a third compliance line 636 for third subreach 610. These compliance lines correspond to the percentage of pollutant load which must be removed per regulations or TMDL for each subreach in both pounds and percent based upon modeled information in Table 1.

As shown in FIGS. 7 and 8, the arc length attributable to each BMP corresponds to the volume of pollutants removed using each BMP. As noted in FIG. 7, each subreach has a compliance gap 614, 620, and 630, respectively, when using the modeled data, which must be addressed to obtain compliance.

FIG. 8 shows the same City X 600 displaying the compliance strategy for meeting TSS removal requirements of including at least one private BMP 628 and one new BMP 626. As can be seen in FIG. 8, through actual measurement in this example, the TSS compliance gap 614 and compliance gap 620 are reduced in subreaches 606 and 608, and in subreach 610, the incorporation of new BMP 626 and private BMP 628 result in exceeding the TMDL target line 636. As shown in FIG. 9, which shows an embodiment of display system 400, it is clear that conservative modeled data illustrates reduced performance and noncompliance in a graphical format which models the entire City X, but also shows which reaches or subreaches need more BMP or are already in compliance.

FIGS. 10 and 11 show annotated versions of the plots provided in FIG. 12 related to TP pollutant compliance. In particular, in FIGS. 10, City X 600 includes a first reach 602 and a second reach 604. First reach 602 includes a first subreach 606 and a second subreach 608, and second reach 604 includes a third subreach 610. City X 600 also includes a first BMP 612 in first subreach 606 and an identified first TP compliance gap 650. City X 600 also includes a second BMP 616 and third BMP 618 in second subreach 608 and an identified second TP compliance gap 652. City X 600 also includes a fourth BMP 622 and a fifth BMP 624 in third subreach 610. Further, third subreach 610 may also include a new BMP 626, a private BMP 628, and a TP compliance gap 654. These tables also provide the removal efficiencies and corresponding pollutant loads captured for existing BMPs 612, 616, 618, 622, and 624, new BMP 626, and private BMP 628 corresponding to modeled information (Table 1) and measured data (Table 3). FIGS. 10 and 11 graphically show each subreach 606, 608 and 610, including a first zero reference line 644 for first subreach 606, a second zero reference line 646 for second subreach 608, and a third zero reference line 648 for third subreach 610. These reference lines correspond to zero pollutant load provided by the BMP. Similarly, each subreach 606, 608 and 610, includes a first compliance line 638 for first subreach 606, a second compliance line 640 for second subreach 608, and a third compliance line 642 for third subreach 610. These compliance lines correspond to the percentage of TP pollutant load which must be removed per regulations or TMDL for each subreach in both pounds and percent based upon modeled information in Table 2.

As shown in FIGS. 10-12, the arc length attributable to each BMP corresponds to the volume of TP pollutants removed using each BMP. As noted in FIG. 10, each subreach has a compliance gap 650, 652, and 654, respectively, when using the modeled data, which must be addressed to obtain compliance.

FIG. 11 shows the same City X 600 displaying the compliance strategy for meeting TP removal requirements of including at least one private BMP 628 and one new BMP 626 in the third subreach 610. As can be seen in FIG. 11, through actual measurement in this example, the TP compliance gaps 650, and 652 are reduced in subreaches 606 and 610. Further, though actually observing the performance of subreach 608, it was shown that BMPs 616 and 618 are sufficient to meet the TMDL target for TP removal in such subreach 608. As shown in FIG. 12, which shows the display system 400, it is clear that conservative modeled data illustrates reduced performance and non-compliance in a graphical format which models the entire City X, but also shows which reaches or subreaches need more BMPs or are already in compliance when looking at the actual performance of the BMP versus the design values.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

TABLE 1
Community X pollutant loads captured with modeled removal efficiencies.

| | | Pollutant Loads Captured - With Modeled Removal Efficiencies | | | | | | | | | | | |
|---|---|---|---|---|---|---|---|---|---|---|---|---|---|
| | | BMP 1 | | BMP 2 | | BMP 3 | | BMP 4 | | BMP 5 | | — | |
| | | TSS | TP | TSS | TP | TSS | TP | TSS | TP | TSS | TP | TSS | TP |
| Subreach | Subreach | Removal | | Removal | | Removal | | Removal | | Removal | | Removal | |
| Baseline | Baseline | Efficiency | | Efficiency | | Efficiency | | Efficiency | | Efficiency | | Efficiency | |
| TSS Load | TP Load | 65% | 35% | 75% | 45% | 60% | 40% | 80% | 55% | 80% | 40% | 0% | 0% |
| (lbs) | (lbs) | (lbs) | | (lbs) | | (lbs) | | (lbs) | | (lbs) | | (lbs) | |
| 5175.0 | 53.2 | 1125.0 | 4.0 | | | | | | | | | 0.0 | 0.0 |
| 2820.0 | 48.1 | | | 566.3 | 7.0 | 427.5 | 8.0 | | | | | 0.0 | 0.0 |
| 10200.0 | 109.0 | | | | | | | 2000.0 | 8.0 | 1200.0 | 11.0 | 0.0 | 0.0 |

| | | | | | | | | | | | | |
|---|---|---|---|---|---|---|---|---|---|---|---|---|
| [symbol] ward Reach Goal (%) | 14.1% | 3.9% | 7.1% | 6.9% | 5.3% | 7.9% | 19.6% | 7.3% | 11.8% | 10.1% | 0.0% | 0.0% |

| | | Pollutant Loads Captured - With Modeled Removal Efficiencies | | | | | |
|---|---|---|---|---|---|---|---|
| | | — | | | | | |
| | | TSS | TP | | | | |
| Subreach | Subreach | Removal | | Reach | Reach | Reach | Reach |
| Baseline | Baseline | Efficiency | | TSS | TSS | TP | TP |
| TSS Load | TP Load | 0% | 0% | Progress | Progress | Progress | Progress |
| (lbs) | (lbs) | (lbs) | | (lbs) | (%) | (lbs) | (%) |
| 5175.0 | 53.2 | 0.0 | 0.0 | 2118.75 | 26.5% | 19 | 18.8% |
| 2820.0 | 48.1 | 0.0 | 0.0 | | | | |
| 10200.0 | 109.0 | 0.0 | 0.0 | 3200 | 31.4% | 19 | 17.4% |

| | | |
|---|---|---|
| [symbol] ward Reach Goal (%) | 0.0% | 0.0% |

[symbol]

indicates data missing or illegible when filed

TABLE 2
Community X pollutant loads captured with modeled removal efficiencies and corresponding cost gaps.

| | Reach | Reach | TMDL | | TMDL | | Modeled | | Modeled | |
|---|---|---|---|---|---|---|---|---|---|---|
| | Baseline | Baseline | Required TSS | | Required TP | | Existing TSS | | Existing TP | |
| Watershed/ | TSS Load | TP Load | Reduction | | Reduction | | Reduction | | Reduction | |
| Reach | (lbs) | (lbs) | (%) | (lbs) | (%) | (lbs) | (%) | (lbs) | (%) | (lbs) |
| 1 | 7995.0 | 101.3 | 56.5% | 4518.8 | 43.7% | 44.3 | 26.5% | 2118.8 | 18.7% | 19.0 |
| 2 | 10200.0 | 109.0 | 60.8% | 6200.0 | 54.1% | 59.0 | 31.4% | 3200.0 | 17.4% | 19.0 |

| | TSS | | TP | | Avg. TSS | Avg. TP | | |
|---|---|---|---|---|---|---|---|---|
| | Pollutant | | Pollutant | | Removal | Removal | TSS | TP |
| Watershed/ | Reduction Gap | | Reduction Gap | | Cost | Cost | Cost | Cost |
| Reach | (%) | (lbs) | (%) | (lbs) | ($/lb) | ($/lb) | Gap | Gap |
| 1 | [symbol] .0% | [symbol] | 2 [symbol] .0% | 25.3 | $9 | $3,500 | $21 [symbol] | $ [symbol] |
| 2 | [symbol] .4% | [symbol] | 36. [symbol] % | 40.0 | | | $26 [symbol] | $ [symbol] |

[symbol]

indicates data missing or illegible when filed

TABLE 3
Community X pollutant loads captured with measured removal efficiencies.

| | | | | Sub- | Sub- | Pollutant Loads Captured - With Measured Removal Efficiencies | | | | | | | | | |
|---|---|---|---|---|---|---|---|---|---|---|---|---|---|---|---|
| | Reach | Reach | | reach | reach | BMP 1 | | BMP 2 | | BMP 3 | | BMP 4 | | BMP 5 | |
| | Base- | Base- | | Base- | Base- | TSS | TP | TSS | TP | TSS | TP | TSS | TP | TSS | TP |
| | line | line | | line | line | Removal | | Removal | | Removal | | Removal | | Removal | |
| Water- | TSS | TP | | TSS | TP | Efficiency | | Efficiency | | Efficiency | | Efficiency | | Efficiency | |
| shed/ | Load | Load | Sub- | Load | Load | 100% | 99% | 93% | 59% | 80% | 59% | 100% | 100% | 80% | 40% |
| Reach | (lbs) | (lbs) | reach | (lbs) | (lbs) | (lbs) | | (lbs) | | (lbs) | | (lbs) | | (lbs) | |
| 1 | 7995 | 101 | 1 | 5175.0 | 53.2 | 1730.8 | 11.4 | | | | | | | | |
| | | | 2 | 2820.0 | 48.1 | | | 702.2 | 9.2 | 570.0 | 11.8 | | | | |
| 2 | 10200 | 109 | 3 | 10200.0 | 109.0 | | | | | | | 2500.0 | 14.5 | 1200.0 | 11.0 |

| | | | | | | | | | | |
|---|---|---|---|---|---|---|---|---|---|---|
| Removal Efficiency Increase | [symbol] | [symbol] | [symbol] | [symbol] | [symbol] | [symbol] | [symbol] | [symbol] | 0% | 0% |
| through Measured Infiltration (%) | | | | | | | | | | |
| BMP Contribution | 21.6% | 11.2% | 8.8% | 9.1% | 7.1% | 11.6% | 24.5% | 13.3% | 11.8% | 10.1 |
| toward Reach Goal (%) | | | | | | | | | | |

| | | | | | | Pollutant Loads Captured - With Measured Removal Efficiencies | | | | | | | |
|---|---|---|---|---|---|---|---|---|---|---|---|---|---|
| | | | | Sub- | Sub- | | | Private | | | | | |
| | Reach | Reach | | reach | reach | BMP 6 | | BMP 1 | | | | | |
| | Base- | Base- | | Base- | Base- | TSS | TP | TSS | TP | Reach | Reach | Reach | Reach |
| | line | line | | line | line | Removal | | Removal | | TSS | TSS | TP | TP |
| Water- | TSS | TP | | TSS | TP | Efficiency | | Efficiency | | Prog- | Prog- | Prog- | Prog- |
| shed/ | Load | Load | Sub- | Load | Load | 100% | 100% | 100% | 100% | ress | ress | ress | ress |
| Reach | (lbs) | (lbs) | reach | (lbs) | (lbs) | (lbs) | | (lbs) | | (lbs) | (%) | (lbs) | (%) |
| 1 | 7995 | 101 | 1 | 5175.0 | 53.2 | | | | | 3003.0 | 37.6% | 32.4 | 31.9% |
| | | | 2 | 2820.0 | 48.1 | | | | | | | | |
| 2 | 10200 | 109 | 3 | 10200.0 | 109.0 | 950.0 | 5.5 | 2650.0 | 5.0 | 7300.0 | 71.6% | 36.0 | 33.0% |

| | | | | |
|---|---|---|---|---|
| Removal Efficiency Increase | [symbol] | [symbol] | [symbol] | [symbol] |
| through Measured Infiltration (%) | | | | |
| BMP Contribution | 9.3% | 5.0% | 26.0% | 4.6% |
| toward Reach Goal (%) | | | | |

[symbol]

indicates data missing or illegible when filed

TABLE 4
Community X pollutant loads captured with measured removal efficiencies and corresponding cost gaps.

| | Reach | Reach | TMDL | | TMDL | | Measured | | Measured | | TSS Pollutant | |
|---|---|---|---|---|---|---|---|---|---|---|---|---|
| | Baseline | Baseline | Required TSS | | Required TP | | Existing TSS | | Existing TP | | Reduction | |
| Watershed/ | TSS Load | TP Load | Reduction | | Reduction | | Reduction | | Reduction | | Gap | |
| Reach | (lbs) | (lbs) | (%) | (lbs) | (%) | (lbs) | (%) | (lbs) | (%) | (lbs) | (%) | (lbs) |
| 1 | 7995.0 | 101.3 | 56.5% | 4518.8 | 43.7% | 44.3 | 37.6% | 3003.0 | 31.9% | 32.4 | [symbol] | [symbol] |
| 2 | 10200.0 | 109.0 | 60.8% | 6200.0 | 54.1% | 59.0 | 71.6% | 7300.0 | 33.0% | 36.0 | [symbol] | [symbol] |

| | TP Pollutant | | Avg. TSS | Avg. TP | | TSS Cost Savings | | TP Cost Savings |
|---|---|---|---|---|---|---|---|---|
| | Reduction | | Removal | Removal | TSS | using Measured | TP | using Measured |
| Watershed/ | Gap | | Cost | Cost | Cost | Removal | Cost | Removal |
| Reach | (%) | (lbs) | ($/lb) | ($/lb) | Gap | Efficiencies | Gap | Efficiencies |
| 1 | [symbol] | [symbol] | $9 | $3,500 | $ [symbol] | $ [symbol] | $ [symbol] | $ [symbol] |
| 2 | [symbol] | [symbol] | | | $ [symbol] | $ [symbol] | $ [symbol] | $ [symbol] |

[symbol]

indicates data missing or illegible when filed

What is claimed is:

1. A method of displaying information related to one or more stormwater best management practices (“BMPs”) implemented by a municipality comprising:
determining an amount of pollutants removed by each of the one or more BMPs; and
presenting information for monitoring stormwater infrastructure efficiency and progress related to governmental compliance by displaying a sunburst chart, wherein the sunburst chart comprises:
a first ring having one or more first ring portions each corresponding to a respective reachshed or sub-reachshed, wherein each of the one or more first ring portions has an arc length sized according to a total amount of pollutant possible within the corresponding reachshed or sub-reachshed; and
a second ring, concentric with the first ring, having one or more BMP second ring portions each corresponding to one of the one or more BMPs and one or more compliance second ring portions each corresponding to a compliance gap,
wherein an arc length of each of the one or more BMP second ring portions corresponds to a respective volume of pollutants removed using a respective BMP, and
wherein the compliance gap is a difference between the volume of pollutants removed using the respective BMP and an amount of pollutant load which must be removed according to the regulations dictated by the governmental compliance.

2. The method of claim 1, wherein one of the one or more BMPs is permeable pavement, a bioswale, an underground infiltration basin, a biofiltration basin, a wet pond, a dry pond, an underground storage cistern, or a green/blue roof system.

3. The method of claim 1, wherein determining the amount of pollutants removed by each of the one or more BMPs further comprises:
determining a modeled amount of pollutants removed by each of the one or more BMPs.

4. The method of claim 1, wherein determining the amount of pollutants removed by each of the one or more BMPs further comprises:
determining a measured amount of pollutants removed by each of the one or more BMPs, the measured amount of pollutants determined using at least a respective internet of things (“IoT”) sensor at each of the one or more BMP;
wherein the IoT sensor measures a concentration of one or more pollutants in stormwater runoff, water clarity in the stormwater runoff, or another water quality characteristic of the stormwater runoff.

5. The method of claim 1, wherein determining the amount of pollutants removed by each of the one or more BMPs further comprises:
measuring a fluid level using a fluid level sensor at each of the one or more BMPs;
measuring rainfall and weather information using environmental sensors at each of the one or more BMPs; and
modeling the amount of pollutants removed by each of the one or more BMPs using measured data to improve calculations performed according to industry design guidelines.

6. The method of claim 1, wherein at least one of the one or more BMP second ring portions corresponds to a private BMP or a new BMP.

7. The method of claim 1, further comprises displaying the BMP second ring portion corresponding to the private BMP or the new BMP differently than the BMP second ring portion corresponding to a BMP second ring portion corresponding to a BMP owned by the municipality.

8. The method of claim 1, further comprising a third ring, concentric with the first ring, having one or more third ring portions each corresponding to a respective sub-reachshed, wherein each of the one or more third ring portions has an arc length sized according to a total amount of pollutant possible within each respective sub-reachshed, and wherein each of the first ring portions corresponds to the respective reachsheds.

9. The method of claim 8, wherein the first ring is an inner-most ring, the third ring is a middle ring, and the second ring is an outer-most ring.

10. The method of claim 1, further comprising
displaying at least one compliance line corresponding to the amount of pollutant load which must be removed according to the regulations dictated by the governmental compliance; and
displaying at least one zero reference line corresponding to a zero pollutant load captured by each of the one or more BMPs.

11. The method of claim 1 wherein the volume of pollutants removed using a respective BMP and the amount of pollutant load which must be removed according to the regulations dictated by the governmental compliance are represented in pounds of pollutant or a percentage.

12. A system configured to display information related to one or more stormwater best management practices (“BMPs”) implemented by a municipality comprising:
one or more BMPs each including at least one sensor;
a memory; and
a processor in communication with the memory and the BMP, wherein the processor is configured to:
determine an amount of pollutants removed by each of the one or more BMPs; and
present information for monitoring stormwater infrastructure efficiency and progress related to governmental compliance by displaying a sunburst chart, wherein the sunburst chart comprises:
a first ring having one or more first ring portions each corresponding to a respective reachshed or sub-reachshed, wherein each of the one or more first ring portions has an arc length sized according to a total amount of pollutant possible within the corresponding reachshed or sub-reachshed; and
a second ring, concentric with the first ring, having one or more BMP second ring portions each corresponding to one of the one or more BMPs and one or more compliance second ring portions each corresponding to a compliance gap,
wherein an arc length of each of the one or more BMP second ring portions corresponds to a respective volume of pollutants removed using a respective BMP, and
wherein the compliance gap is a difference between the volume of pollutants removed using the respective BMP and an amount of pollutant load which must be removed according to the regulations dictated by the governmental compliance.

13. The system of claim 12, wherein one of the one or more BMPs is permeable pavement, a bioswale, an underground infiltration basin, a biofiltration basin, a wet pond, a dry pond, an underground storage cistern, or a green/blue roof system.

14. The system of claim 12, wherein the processor determines the amount of pollutants removed by each of the one or more BMPs by being further configured to determine a modeled amount of pollutants removed by each of the one or more BMPs.

15. The system of claim 12, wherein the processor determines the amount of pollutants removed by each of the one or more BMPs by being further configured to:
determine a measured amount of pollutants removed by each of the one or more BMPs, the measured amount of pollutants determined using the sensor at each of the one or more BMP;
wherein the sensor measures a concentration of one or more pollutants in stormwater runoff, water clarity in the stormwater runoff, or another water quality characteristic of the stormwater runoff.

16. The system of claim 12, wherein determining the amount of pollutants removed by each of the one or more BMPs further comprises:
the sensor measuring a fluid level at each of the one or more BMPs;
environmental sensors measuring rainfall and weather information at each of the one or more BMPs; and
wherein the processor is further configured to receive the fluid level at each of the one or more BMPs and the rainfall and weather information at each of the one or more BMPs and model the amount of pollutants removed by each of the one or more BMPs using measured data to improve calculations according to industry design guidelines.

17. The system of claim 12, wherein at least one of the one or more BMP second ring portions corresponds to a private BMP or a new BMP.

18. The system of claim 12, wherein the processor is further configured to display the BMP second ring portion corresponding to the private BMP or the new BMP differently than the BMP second ring portion corresponding to a BMP second ring portion corresponding to a BMP owned by the municipality.

19. The system of claim 12, wherein the sunburst chart further comprises a third ring, concentric with the first ring, having one or more third ring portions each corresponding to a respective sub-reachshed, wherein each of the one or more third ring portions has an arc length sized according to a total amount of pollutant possible within each respective sub-reachshed, and wherein each of the first ring portions corresponds to the respective reachsheds.

20. The system of claim 19, wherein the first ring is an inner-most ring, the third ring is a middle ring, and the second ring is an outer-most ring.
